(19) United States
(12) Patent Application Publication
(10) Pub. No.: US 2026/0261540 A1
(43) Pub. Date: Sep. 3, 2026

(54) DERIVING ADDRESS RESOLUTION PROTOCOL (ARP) BINDINGS USING DYNAMIC HOST CONFIGURATION PROTOCOL (DHCP) RELAY

(71) Applicant: Arista Networks, Inc., Santa Clara, CA (US)

(72) Inventors: Purushothaman Nandakumaran, Milpitas, CA (US); Victor Wen, San Jose, CA (US)

(21) Appl. No.: 19/066,957

(22) Filed: Feb. 28, 2025

(51) Int. Cl. H04L 61/103; H04L 61/5014; H04L 61/59; H04L 61/10

(52) U.S. Cl. CPC H04L 61/103; H04L 61/5014; H04L 61/59; H04L 61/10

(57) ABSTRACT

A method of operating a network device is provided that includes performing a dynamic host configuration protocol (DHCP) handshake by relaying a series of messages between a host device and a server, deriving an IP-to-MAC binding for the host device from the series of relayed messages, and programming a static address resolution protocol (ARP) entry in an ARP table using the derived IP-to-MAC binding for the host device. The method can further include managing a lifetime of the static entry in the ARP table by querying a lease duration from the server, by intercepting renew or release messages sent from the client device to the server, or by sending one or more unicast ARP requests to the host device.

### BACKGROUND

A network device such as a wireless gateway can be configured to route or switch traffic between various components in a network. Certain routing schemes may require replicating a packet and broadcasting the replicated packets to a large number of corresponding network components coupled. A network device can include a packet replication module having an upper limit on the maximum number of replications that is supported by the module.

In certain scenarios or applications, however, a user of the network device might want to operate such a network device to perform a number of replications that exceeds the upper limit. Current state-of-the-art network devices, however, cannot support such operation. It is within such context that the embodiments herein arise.

### BRIEF DESCRIPTION OF THE DRAWINGS

FIG. 1 is a diagram of an illustrative network device configured to route and/or switch data packets in accordance with some embodiments.

FIG. 2 is a diagram of an illustrative gateway device coupled to the Internet, a DHCP (Dynamic Host Configuration Protocol) server, and various wireless access points in accordance with some embodiments.

FIG. 3 is a flowchart of illustrative steps for deriving IP-to-MAC bindings using DHCP handshake operations and installing a static ARP (Address Resolution Protocol) entry in accordance with some embodiments.

FIG. 4 is a diagram of an illustrative ARP table in accordance with some embodiments.

FIG. 5 is a flowchart of illustrative steps for selectively updating one or more static ARP entries via a DHCP lease query in accordance with some embodiments.

FIG. 6 is a flowchart of illustrative steps for selectively updating one or more static ARP entries using DHCP renew and release messages in accordance with some embodiments.

FIG. 7 is a flowchart of illustrative steps for selectively removing a static ARP entry using unicast ARP requests in accordance with some embodiments.

FIG. 8 is a diagram showing illustrative hardware components that can be included within a data processing system in accordance with some embodiments.

### DETAILED DESCRIPTION

A network device can include one or more processors such as a packet processor configured to handle data packets. In layer 2 (L2) or other local area networks, including virtual local area networks (VLANs), the packet processor can receive a packet that needs to be broadcasted. For example, an L2 network can include a WiFi gateway device coupled to a large number of wireless access points via virtual tunnels. Each wireless access point can be communicatively coupled to one or more end hosts (client devices). When the WiFi gateway device receives traffic intended for an end host for which the gateway does not know the end host’s MAC address, the gateway will need to broadcast an Address Resolution Protocol (ARP) request to all wireless access points in the network to discover an IP-to-MAC binding for that particular end host. The gateway device can employ a hardware replication mechanism to replicate the ARP request to all associated wireless access points. Such hardware replication mechanism can work for smaller networks. For larger networks, however, the number of replications needed for the ARP broadcast might exceed a hardware replication limit of the gateway device.

To address such limitation, a network device such as a WiFi gateway device can be configured to learn the IP-to-MAC bindings via a Dynamic Host Configuration Protocol (DHCP) handshake process between the end hosts and a DCHP server. A DHCP relay agent executed on the gateway device can facilitate the initial DHCP handshake process between the DHCP server and the various end hosts. The DHCP relay agent can publish a list or table of IP-to-MAC bindings based on DHCP messages being relayed between the DHCP server and the end hosts. IP-to-MAC bindings learned via the DHCP handshake process can be used to install static ARP entries, which do not age out. Different gateway devices can optionally exchange such binding information via Border Gateway Protocol (BGP), Ethernet Virtual Private Network (EVPN) or other mechanism so that each gateway device has the complete binding information.

The DHCP relay agent can maintain the static ARP entries for the entirety of a DHCP lease duration. Various ways for managing the lifetime of the static ARP entries are provided herein. In one embodiment, the DHCP relay agent periodically queries the DHCP server for its current bindings and then updates the static ARP bindings based on the query results. In another embodiment, the DHCP relay agent inserts a server ID override option during the initial DHCP handshake process so that the host(s) can send renew/release messages to the DHCP server, which allows the DHCP server to update the static ARP bindings based on any renew/release messages. In yet another embodiment, the DHCP relay agent can send one or more unicast ARP requests to a given host, and based on a number of responses from the given host, the DHCP relay agent can selectively update or remove the static ARP binding for the given host.

Configuring and operating an L2 network in this way can be technically advantageous and beneficial to help avoid or bypass the use of dynamic ARP entries, which can minimize the need to broadcast ARP requests to a large number of wireless access points for discovering IP-to-MAC bindings for an end host, thereby circumventing the packet replication limitation.

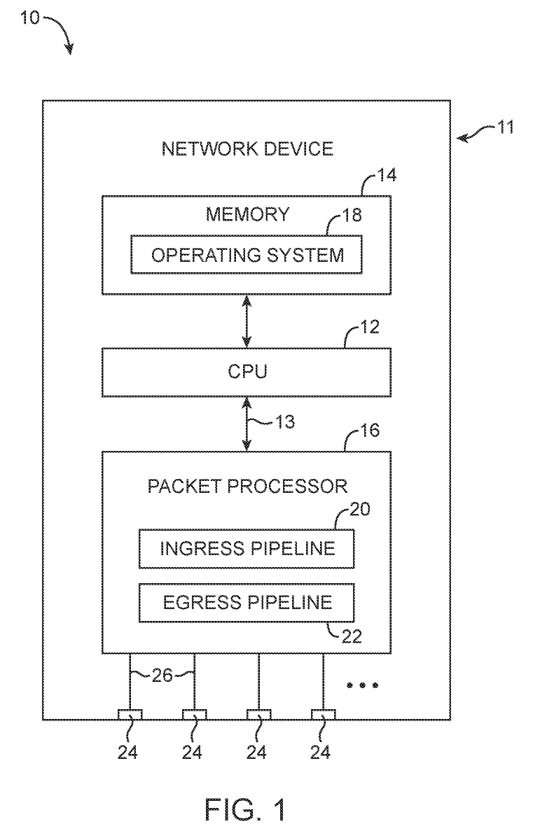

As shown in FIG. 1, a network device such as network device 10 may be a gateway, router, a switch, a bridge, a hub, a repeater, a firewall, a device serving other networking functions, a network device that includes a combination of these functions, or other types of network elements. As shown in FIG. 1, network device 10 may include processing circuitry such as a central processing unit (CPU) 12, storage circuitry including memory 14, and a packet processing circuit such as packet processor 16 all disposed within a housing 11 of device 10. Housing 11 may be an exterior cover (e.g., a plastic exterior shell, a metal exterior shell, or an exterior shell formed from other rigid or semirigid materials) that provides structural support and protection for the components disposed within the housing. In general, processing unit 12 may represent processing circuitry based on one or more microprocessors, graphics processing units (GPUs), host processors, general-purpose processors, microcontrollers, digital signal processors, application-specific integrated circuits (ASICs), application-specific system processors (ASSPs), programmable logic devices such as field-programmable gate arrays (FPGAs), power management integrated circuits (PMICs), a combination of these processors, or other types of processors. Central processing unit 12 may sometimes be referred to herein as a main processor 12. In general, central processing unit 12 can be implemented using one or more processors.

Processor 12 may be used to run a network device operating system such as operating system (OS) 18 and/or other software/firmware that is stored on memory 14. Memory 14 may include non-transitory (tangible) computer readable storage media that stores operating system 18 and/or any software code, sometimes referred to as program instructions, software, data, instructions, or code. Memory 14 may include nonvolatile memory (e.g., flash memory or other electrically-programmable read-only memory configured to form a solid-state drive), volatile memory (e.g., static or dynamic random-access memory), hard disk drive storage, and/or other storage circuitry. The processing circuitry and storage circuitry described above are sometimes referred to collectively as storage and processing circuitry or control circuitry. Processor 12 and memory 14 are thus sometimes referred to as being part of a “control plane” of network device 10.

Operating system 18 running in the control plane of network device 10 may exchange network topology information with other network devices using a routing protocol. Routing protocols are software mechanisms by which multiple network devices communicate and share information about the topology of the network and the capabilities of each network device. For example, network routing protocols executed on device 10 may include Border Gateway Protocol (BGP) or other distance vector routing protocols, Enhanced Interior Gateway Routing Protocol (EIGRP), Exterior Gateway Protocol (EGP), Routing Information Protocol (RIP), Open Shortest Path First (OSPF) protocol, Label Distribution Protocol (LDP), Multiprotocol Label Switching (MPLS), intermediate system to intermediate system (IS-IS) protocol, Protocol Independent Multicast (PIM), Virtual Routing Redundancy Protocol (VRRP), Hot Standby Router Protocol (HSRP), and/or other Internet routing protocols (just to name a few).

Processor 12 may be coupled to packet processor 16 via path 13. Packet processor 16 is oftentimes referred to as being part of a “data plane” or “forwarding plane.” Packet processor 16 may represent processing circuitry based on one or more network processing units, microprocessors, general-purpose processors, application specific integrated circuits (ASICs), programmable logic devices such as field-programmable gate arrays (FPGAs), a combination of these processors, or other types of processors. Packet processor 16 may be coupled to input-output ports 24 via paths 26 and receives and outputs data packets via input-output ports 24. Ports 24 that receive data packets from other network elements are sometimes referred to as “ingress” ports, whereas ports 24 through which packets exit out of device 10 towards other network elements are sometimes referred to as “egress” ports. Ports 24 are sometimes referred to collectively as ingress-egress or input-output ports.

Packet processor 16 can analyze the received data packets, process the data packets in accordance with a network protocol, and forward (or optionally drop) the data packets accordingly. Data packets received in the data plane may optionally be analyzed in the control plane to handle more complex signaling protocols. Memory 14 may include information about the speed(s) of input-output ports 24, information about any statically and/or dynamically programmed routes, any critical table(s) such as forwarding tables or forwarding information base (FIB), critical performance settings for packet processor 16, other forwarding data, and/other information that is needed for proper function of packet processor 16.

A data packet is generally a formatted unit of data conveyed over a network. Data packets conveyed over a network are sometimes referred to as network packets. A group of data packets intended for the same destination should have the same forwarding treatment. A data packet typically includes control information and user data (payload). The control information in a data packet can include information about the packet itself (e.g., the length of the packet and packet identifier number) and address information such as a source address and a destination address. The source address represents an Internet Protocol (IP) address that uniquely identifies the source device in the network from which a particular data packet originated. The destination address represents an IP address that uniquely identifies the destination device in the network at which a particular data packet is intended to arrive.

Data packets received in the data plane may optionally be analyzed in the control plane to handle more complex signaling protocols. Packet processor 16 may be configured to partition data packets received at an ingress port 24 into groups of packets based on their destination address and to choose a next hop device for each data packet when exiting an egress port 24. The choice of next hop device for each data packet may occur through a hashing process (as an example) over the packet header fields, the result of which is used to select from among a list of next hop devices in a routing table stored on memory in packet processor 16. Such routing table listing the next hop devices for different data packets is sometimes referred to as a hardware forwarding table, or a hardware forwarding information base (FIB). The routing table may list actual next hop network devices that are currently programmed on network device 10 for each group of data packets having the same destination address. If desired, the routing table may also list actual next hop devices currently programmed for device 10 for multiple destination addresses (i.e., device 10 can store a single hardware forwarding table separately listing programmed next hop devices corresponding to different destination addresses). The example of FIG. 1 showing four ingress-egress ports 24 is merely illustrative. In general, packet processor 16 can be coupled to up to ten input-output ports 24, up to twenty input-output ports 24, up to thirty input-output ports 24, up to fifty input-output ports 24, up to a hundred input-output ports 24, or more than a hundred input-output ports 24.

Packet processing block 16 of FIG. 1 may generally represent one or more packet processors. Each packet processor 16 may include a packet processing pipeline that includes an ingress pipeline 20 and an egress pipeline 22. Each port 24 may have its own ingress pipeline 20 and its own egress pipeline 22. Data packets received at an ingress port 24 may be processed by an ingress pipeline 20 associated with that ingress port, whereas data packets transmitted from an egress port 24 may be processed using an egress pipeline 22 associated with that egress port. Ingress pipeline 20 may forward a data packet to egress pipeline 22 corresponding to a port 24 on which the packet will egress from device 10. Ingress pipeline 20 may include selection circuitry (sometimes referred to as a selector) configured to direct an intermediate data packet and associated metadata produced in the ingress pipeline to an appropriate egress pipeline 22. The selector within ingress pipeline 20 can select an egress pipeline 22 based on information contained in the received data packet.

In some embodiments, network device 10 can be based on a scalable architecture that includes multiple interconnected network chips where the packet processing functionality is distributed between separate ingress and egress pipelines. For example, ingress pipeline 20 and egress pipeline 22 can be implemented using separate logic circuitry. As another example, ingress pipeline 20 and egress pipeline 22 can be implemented as part of separate integrated circuit (IC) chips.

Ingress pipeline 20 can include a parser and a processing engine, sometimes referred to as an ingress parser and an ingress processing engine, respectively. Ingress pipeline 20 can use ingress lookup and editing tables (sometimes referred to as ingress data tables) to provide editing instructions based on the contents of an ingress data packet to drive the ingress processing engine. Generally, when a data packet is received on a port 24 of network device 10, the received data packet feeds into an ingress pipeline 20 associated with that port 24. The parser of that ingress pipeline 20 parses the received data packet to access portions of the data packet. The parsed information can be used as search/lookup keys into ingress data tables to produce metadata that is then used to identify a corresponding egress pipeline and to direct processing in the egress pipeline (e.g., to bridge or route the data packet, to selectively add a tunnel header, etc.).

In some instances, lookup operations can be performed using the ingress data tables to obtain editing instructions that feed into the processing engine to direct editing actions on the data packet. In other instances, the ingress packet might not be edited. In either scenario, the data packet output from an ingress pipeline can sometimes be referred to herein as an “intermediate packet.” The intermediate data packet and the metadata output from an ingress pipeline can be forwarded by its associated selector and queued towards an appropriate egress pipeline. In some embodiments, the selector can select the egress pipeline based on information contained in the metadata and/or information contained in the ingress data packet.

Egress pipeline 22 can include its own parser and processing engine. The egress pipeline can include a parser and a processing engine, sometimes referred to as an egress parser and an egress processing engine, respectively. The egress pipeline can access egress lookup and editing tables (sometimes referred to as egress data tables) to provide editing instructions to the egress processing engine. Generally, when the selector transmits the intermediate data packet from the ingress pipeline to the egress pipeline, the egress parser of the egress pipeline can parse the received intermediate packet to access portions of that packet. Various lookups can be performed on the egress data tables using the parsed data packet and the metadata to obtain appropriate editing instructions that feed into the egress processing engine. The editing instructions can direct actions performed by the egress processing engine to produce a corresponding egress data packet.

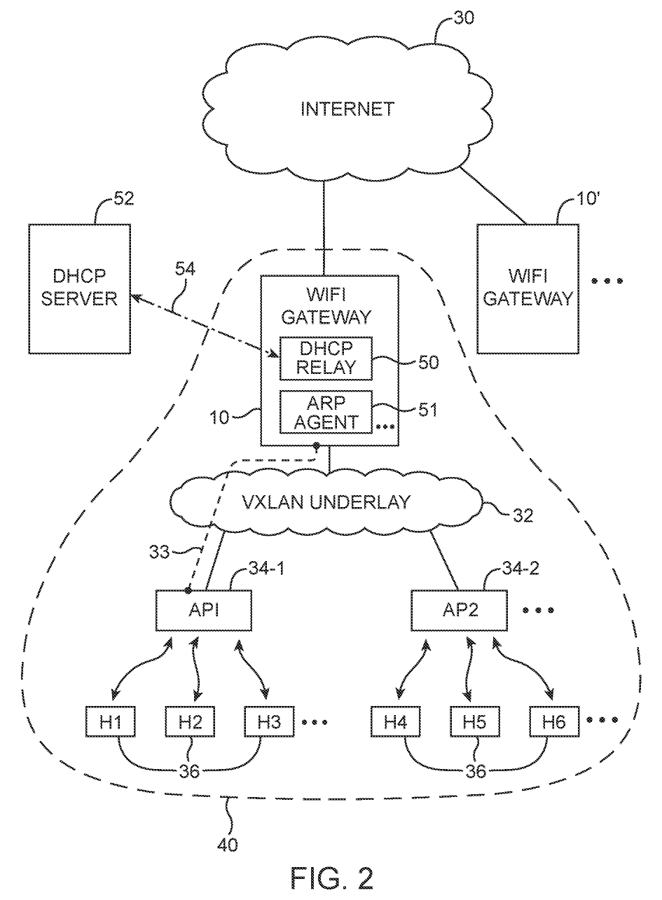

FIG. 2 is a diagram showing how an illustrative network device such as a WiFi gateway 10 can be coupled to various network components in accordance with some embodiments. A WiFi gateway 10 can refer to and be defined herein as a network device that acts as a router between Internet 30 and other devices in a layer 2 (L2) or other local area network. Internet 30 can be coupled to one or more WiFi gateways (see, e.g., gateway device 10 and gateway device 10’). In particular, a WiFi gateway 10 may have wireless interfaces configured to provide Internet connectivity to wireless devices connected to respective access points in accordance with the WiFi protocol defined by the Institute of Electrical and Electronics Engineers (IEEE) 802.11 standards.

Gateway device 10 can be communicatively coupled to one or more access points 34 either directly or via any tunneling protocol. As an example, a network underlay such as a Virtual Extensible local area network (VXLAN) underlay 32 can be used to implement a VXLAN tunneling protocol. Such type of network underlay 32 is exemplary. In general, underlay 32 can be implemented using any tunneling protocol. The VXLAN underlay 32 can serve as a physical network infrastructure through which VXLAN overlay traffic is conveyed. VXLAN underlay 32 can be configured to provide a transport layer for encapsulated VXLAN traffic between respective endpoints. In a VXLAN, the endpoints can sometimes be referred to as VXLAN tunnel endpoints (VTEPs). In the example of FIG. 2, VXLAN underlay 32 can be configured to provide virtual tunnels (e.g., VXLAN tunnels) between a gateway device and various access points 34. As an example, a virtual tunnel 33 traversing VXLAN underlay 32 can have one end coupled to WiFi gateway 10 and another end coupled to access point 34-1. As another example, gateway 10 can be communicatively coupled to another access point 34-2 via an additional virtual tunnel through VXLAN underlay 32. In general, gateway 10 can be communicatively coupled, via underlay 32, to one or more access points 34, two to ten access points 34, 10 to 100 access points 34, hundreds of access points 34, thousands of access points, or more than ten thousand access points 34.

An access point 34 can refer to and be defined herein as a network device that provides Internet connection to associated end hosts 36 using wireless (e.g., WiFi) signals. Such access point 34 that broadcasts wireless signals to end host devices 36 within its coverage area can be referred to as a “wireless” access point (AP) device. In contrast to a router which directs traffic between different networks, an access point 34 extends a certain network’s wireless coverage. In the example of FIG. 2, wireless access point 34-1 may establish wireless connections with associated end host (client) devices such as hosts H1, H2, and H3, and wireless access point 34-2 may establish wireless connections with associated end host (client) devices such as hosts H4, H5, and H6. This arrangement is exemplary. In general, each wireless access point 34 can be communicatively and wirelessly coupled to one or more host/client devices, two or more host/client devices, two to ten host/client devices, 10-100 host/client devices, or more than 100 host/client devices. In FIG. 2, gateway 10, underlay 32, access points 34, and associated end hosts 36 can all be considered part of a virtual network such as a virtual local area network (VLAN) 40. WiFi gateway 10’ may, for example, be part of a separate VLAN.

Consider a scenario in which a WiFi gateway receives a packet from the Internet that is intended for a given end host. To forward the packet to the given end host, the WiFi gateway can extract from the packet header an IP address for the given end host but will also need to know the media access control (MAC) address of the given end host. In many instances, the WiFi gateway does not yet know the MAC address of the end host. One way to discover the MAC address of the end host is to broadcast an Address Resolution Protocol (ARP) request to associated access points in the virtual network. The Address Resolution Protocol is a communication protocol used to map an IP (e.g., layer 3 or L3) address to a corresponding MAC (e.g., layer 2 or L2) address. Resolving a mapping between IP and MAC addresses is necessary because devices in a network communicate at the lower hardware level using MAC addresses while higher-level protocols rely on IP addresses.

As described above, a WiFi gateway may broadcast an ARP request in the virtual network, which asks the question “who has this IP address?” As an example, the WiFi gateway can be coupled to more than ten thousand access points. In such a scenario, the WiFi gateway would need to replicate an ARP request more than ten thousand times to send corresponding replicated packets to the various access points. Such type of MAC address discovery by broadcasting replicated ARP requests is sometimes referred to herein as “dynamic” ARP learning. The WiFi gateway can, however, have a hardware limit that caps the number of packet replications performed per packet at the gateway. The use of dynamic ARP learning to discover MAC addresses of unknown end hosts is thus sometimes problematic.

In accordance with an embodiment, network subsystems are provided that circumvent or avoid the need to replicate a large number of ARP requests. A gateway device 10 may leverage a Dynamic Host Configuration Protocol (DHCP) relay agent to facilitate a DHCP handshake process with an associated DHCP server and discover IP-to-MAC bindings via the handshake process.

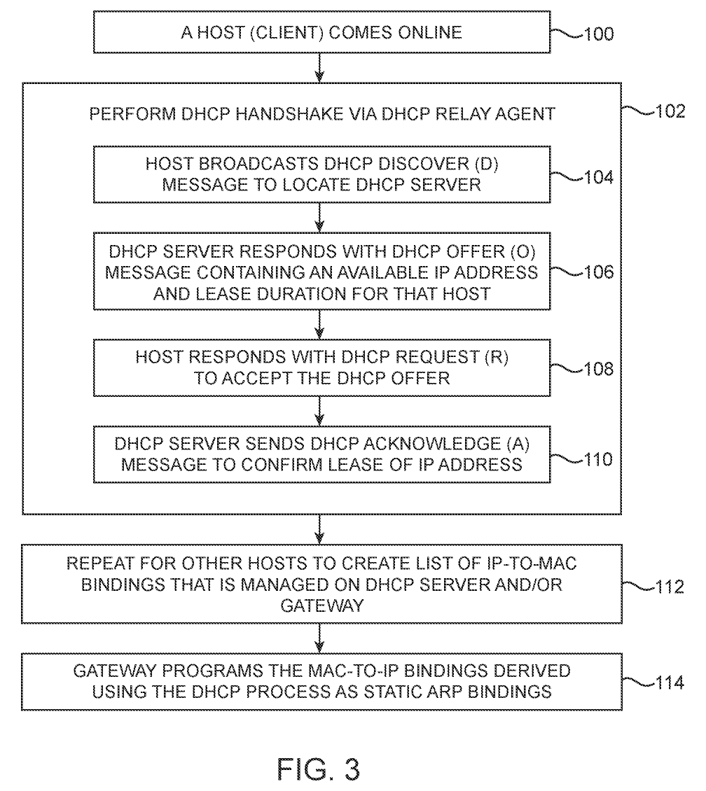

FIG. 3 is a flowchart of illustrative steps for deriving IP-to-MAC bindings using DHCP handshake operations. During the operations of block 100, a host device 36 can come online. Host device 36 is sometimes referred to as a client device. Gateway device 10 may not know a priori the MAC address of a host device 36 that newly comes online. Host device 36 can be powered on or can enter the coverage area of a wireless access point 34.

During the operations of block 102, gateway device 10 can be configured to perform DHCP handshake with DHCP server 52 via a DHCP relay agent. As shown in FIG. 2, a relay agent such as DHCP relay agent 50 running on gateway 10 can be configured to communicate with a server such as DHCP server 52 with communications path 54. Dynamic Host Configuration Protocol (DHCP) can refer to a network management protocol that is used to dynamically assign IP addresses and other network configuration parameters to host/client devices in a network. The DHCP relay agent 50 can represent a software subsystem executed on gateway 10 that forwards DHCP messages between hosts and DHCP server 52 to obtain IP addresses and other network configuration settings from server 52. As an example, DHCP relay agent 50 can run on one or more processors described in connection with FIG. 1. DHCP server 52 can be configured to manage a pool of IP addresses and can dynamically assign an IP address from the pool of IP addresses to a host device. This dynamic assignment of IP address is performed via a DHCP handshake process as outlined by the operations of block 102.

Block 102 can include blocks 104, 106, 108, and 110. Block 104 can represent a DHCP “discover” step. During the operations of block 104, the host device 36 described in connection with block 100 can broadcast a DHCP discover message to locate or find an available DHCP server. The DHCP discover message can include a MAC (hardware) address of host device 36. The DHCP relay agent 50 on gateway device 10 can receive the DHCP discover message and forward that message to an available or associated DHCP server 52.

Block 106 can represent a DHCP “offer” step. During the operations of block 106, a DHCP server 52 that receives the DHCP discover message from the DHCP relay agent 50 can respond with a DHCP offer message that contains an available (offered) IP address and lease duration, among other possible network configuration parameters, for that particular end host 36. The IP address included in the DHCP offer message may represent a proposed IP address from a pool of available IP addresses. The DHCP can proceed to reserve the proposed IP address once the offer is accepted by the host device. The DHCP offer message can optionally include other networking information such as a server identifier (e.g., an IP address of the DHCP server), a subnet mask associated with the offered IP address, a default gateway (e.g., an IP address of gateway device 10), the MAC address of host device 36, etc.

Block 108 can represent a DHCP “request” step. During the operations of block 108, host device 36 receiving the DHCP offer message can then respond with a DHCP request to accept the DHCP offer. This request, sometimes referred to as a DHCP request message, informs DHCP server 52 that the host is accepting the offered IP address, lease duration, and other network settings.

Block 110 can represent a DHCP “acknowledgement” step. During the operations of block 110, DHCP server 52 can send a DHCP acknowledge (ACK) message to confirm the lease of the offered IP address. At this point, the IP address is officially assigned to the host device 36. Such acknowledge message can include the IP address assigned to host 36 and the host’s MAC address (e.g., the client’s MAC address previously provided during the DHCP discover and request phases). At this point, the DHCP relay agent 50 running on gateway device 10 can observe this exchange between DHCP server 52 and host device 36 and can now associate the assigned IP address with the host’s MAC address.

This mapping between the IP address and the MAC address for a given host is sometimes referred to as an “IP-to-MAC binding.” In other words, DHCP relay agent 50 can derive or learn the IP-to-MAC binding for any given host/client device via the DHCP handshake process. DHCP relay agent 50 can be configured to derive IP-to-MAC bindings for more than one host device using DHCP handshake operations. The operations of blocks 100 and 102 captures the flow for a single host in the network. During the operations of block 112, the DHCP relay agent 50 can derive the IP-to-MAC binding(s) for one or more additional hosts as they come online via the DHCP handling process.

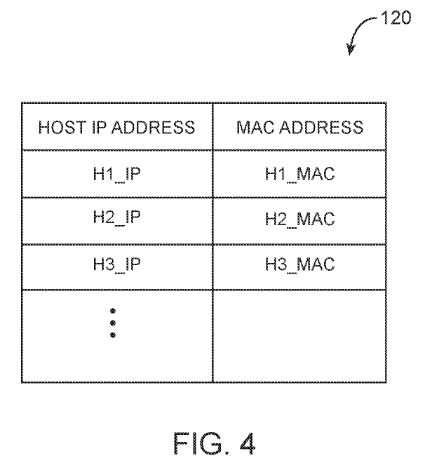

DHCP relay agent 50 can build a table or list of IP-to-MAC bindings for multiple host devices. FIG. 4 is a diagram of an illustrative table 120 of IP-to-MAC bindings. As shown in FIG. 4, a first entry in table 120 includes a mapping of IP address H1_IP to MAC address H1_MAC for a first host H1, a second entry in in table 120 includes a mapping of IP address H2_IP to MAC address H2_MAC for a second host H2, and a third entry in table 120 includes a mapping of IP address H3_IP and MAC address H3_MAC for a third host H3. Table 120 in the example of FIG. 3 that includes IP-to-MAC bindings for three different host devices is illustrative. In general, table 120 can include IP-to-MAC binding information for one or more host/client devices, for two to ten host/client devices, for 10 to 100 host/client devices, or for more than 100 host/client devices. An IP-to-MAC binding is sometimes referred to as an ARP binding. Table 120 of IP-to-MAC bindings for different hosts/clients can thus sometimes be referred to and defined herein as an “ARP table” or an “ARP cache.” ARP table 120 can be maintained by DHCP relay agent 50 and stored internally within gateway device 10 and/or can be separately maintained on DHCP server 52.

The list of IP-to-MAC bindings can be managed centrally at the DHCP server 52 or can be managed locally at each gateway device 10. An ARP table being managed centrally at DHCP server 52 can include entries associated with hosts/clients coupled to different gateway devices connected to that DHCP server 52. In contrast, an ARP table being managed locally at a given gateway device 10 can include entries associated with hosts/clients coupled only to that gateway device 10.

During the operations of block 114, gateway device 10 can be configured to program or install static ARP bindings (entries) in ARP table 120 using the IP-to-MAC bindings derived using the operations of block 102 and 112. In the example of FIG. 2, a software subsystem such as an ARP agent 51 running on gateway device 10 can be configured to install one or more IP-to-MAC bindings in ARP table 120. As an example, ARP agent 51 can be executed on one or more processors described in connection with FIG. 1. In particular, an entry or binding in ARP table 120 can be considered a “static” ARP entry if the mapping between the IP address and the corresponding MAC address is fixed (permanent) and remains in the ARP table until explicitly removed or until the system restarts. Static ARP entries are different than “dynamic” ARP entries, which are not persistent and can expire after a timeout period. Dynamic ARP bindings are learned via ARP requests and replies and are only stored temporarily in the ARP table. Dynamic ARP bindings will be removed from the ARP table if not used or refreshed within a certain time frame. The terms ARP “bindings” or ARP “entries” are sometimes used interchangeably herein to refer to a particular IP-to-MAC mapping in an ARP table/cache.

Although the operations of block 114 are shown as occurring after the operations of block 112, the operations or block 114 can occur before or concurrently with the operations of block 112. As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

The operations of FIG. 3 can thus be used to build a table of static ARP bindings without relying on the conventional dynamic ARP protocol that broadcasts a large number of ARP request. In other words, using the DHCP handshake process to build a table of static ARP entries can be technically advantageous and beneficial to avoid or bypass the dynamic ARP protocol. In certain embodiments, the dynamic ARP protocol can be entirely disabled in one or more parts of the overall network. The operations of FIG. 3 are illustrative. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. In some embodiments, the described operations may be distributed in a larger system.

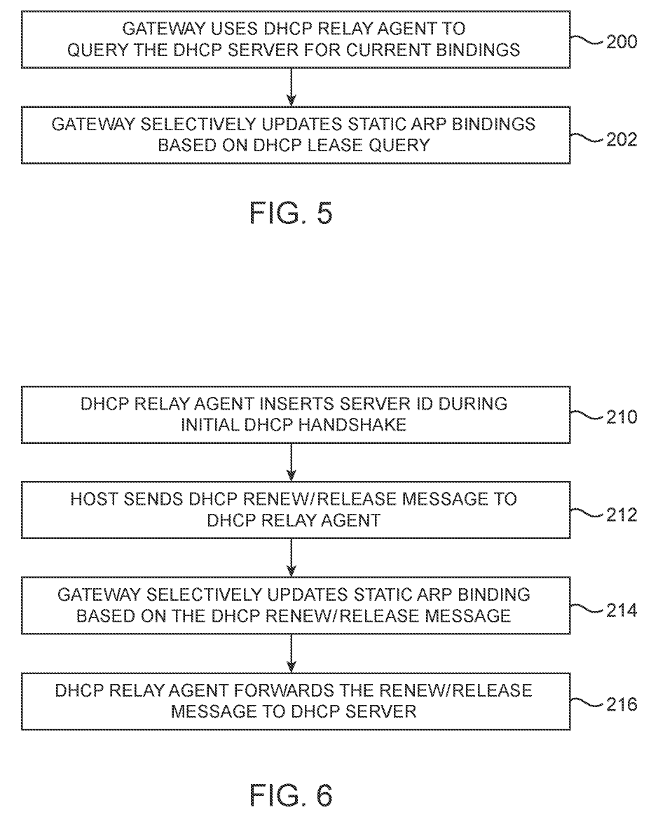

In accordance with some embodiments, a static ARP binding can have a configurable lifetime that is managed using the DHCP relay agent 50. As described in connection with block 106 in FIG. 3, every IP address being offered by the DHCP process has an associated DHCP lease time/duration. Such DHCP lease duration may be included in the DHCP offer message and can be recorded by the DHCP server 52. As an example, DHCP relay agent 50 can manage the lifetime of a static ARP binding based on the DHCP lease duration (see, e.g., FIG. 5). During the operations of block 200, gateway device 10 can be configured to query DHCP server 52 for the current static ARP bindings based on the DHCP leases. DHCP server 52 can then respond with DHCP lease information. In particular, the DHCP server 52 may send to the DHCP relay agent 50 the DHCP lease duration of each ARP binding in the ARP table. The operations of block 200 can be performed periodically.

During the operations of block 202, gateway device 10 can selectively update the static ARP bindings in a local ARP table based on the DHCP lease query results obtained from block 200. As an example, if the query from block 200 returns a lease time that has expired or is invalid, DHCP relay agent 50 can notify ARP agent 51 running on gateway device 10 to remove or delete the corresponding static ARP binding (entry) from the local ARP table. Alternatively, if the query from block 200 returns a lease time that has yet to expire or is still valid, the corresponding static ARP binding (entry) in the local ARP table can be left unaltered or intact. This last step can continue periodically in the background.

The method of FIG. 5 for managing the lifetime of a static ARP binding using DHCP lease queries is exemplary. Additionally or alternatively, FIG. 6 shows another illustrative method for managing the lifetime of a static ARP binding based on DHCP renew and/or release messages. During the operations of block 210, DHCP relay agent 50 can insert a server identifier (ID) during the initial DHCP handshake process. Typically, the server ID of the DHCP server 52 is exchanged between server 52 and the end host during the DHCP handshake process. Here, the DHCP relay agent 50 may add a server ID override option to the discover message, and DHCP server 52 (if it supports this server ID override option) will then use the IP address specified in the option as the server ID when it responds with the offer message. By overriding the DHCP server ID in this way, the host device will forward all unicast DHCP renew/release packets to the DHCP relay agent 50, and the relay agent 50 can then forward the received packets onwards to the DHCP server 52. Operated in this way, the DHCP relay agent 50 will intercept all renew/release messages sent from an end host.

During the operations of block 212, which can occur after the DHCP handshake process, the end host can send a DHCP renew or release message to the DHCP relay agent 50. A DHCP “renew” message can refer to and be defined herein as a message sent by an end host to the DHCP server to renew or extend its lease on an assigned IP address before the lease expires, thereby ensuring uninterrupted network connectivity. A DHCP “release” message can refer to and be defined herein as a message sent by an end host to the DHCP server to inform the server that the host is relinquishing or releasing the assigned IP address, thereby ensuring efficient management of IP address resources on a network. DHCP renew/release messages are conventionally unicast messages between the DHCP server and end hosts and thus bypasses the DHCP relay agent 50. However, the operations of block 210 will ensure that the DHCP relay agent 50 intercepts all renew/release messages output from an end host.

During the operations of block 214, gateway device 10 can selectively update a static ARP binding in a local ARP table based on the DHCP renew/release message it receives during block 212. In response to receiving a DHCP release message from the host/client, ARP agent 51 running on gateway device 10 can remove or delete the corresponding static ARP binding (entry) from the local ARP table. Alternatively, in response to receive a DHCP renew message from the host/client, the corresponding static ARP binding (entry) in the local ARP table can be left unaltered or intact.

During the operations of block 216, DHCP relay agent 50 can then forward the renew/release message onward to the intended DHCP server 52. Although the operations of block 216 are shown as occurring after block 214, the operations of block 216 can occur before or concurrently with block 214.

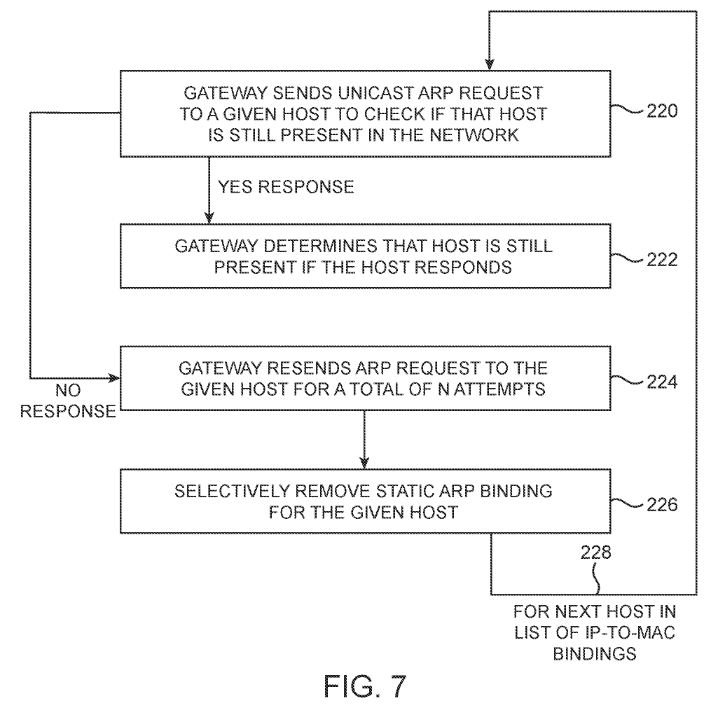

The method of FIG. 6 for managing the lifetime of a static ARP binding using DHCP renew/release messages is exemplary. Additionally or alternatively, FIG. 7 shows another illustrative method for managing the lifetime of a static ARP binding based on ARP requests. During the operations of block 220, gateway device 10 can send a unicast ARP request to a given end host to check if that end host is still present in the network. The operations of block 220 can be performed periodically.

If the end host responds to the unicast ARP request, then gateway device 10 can determine that the end host is still present (see operations of block 222). In such scenarios, the corresponding static ARP binding (entry) in the local ARP table managed on device 10 can be left unaltered or intact.

If, however, the end host does not respond to the unicast ARP request, then gateway device 10 can resend one or more additional ARP requests to the given end host for a total of N attempts (e.g., gateway 10 may attempt to ping the end host N times to check for a response), as shown by the operations of block 224 The number N may represent an integer that is greater than 2, 2-10, 10-50, 50-100, or greater than 100.

If gateway device 10 does not receive any response after N attempts, then device 10 may selectively remove the static ARP binding for the given end host, as shown by the operations of block 226. In particular, ARP agent 51 running on gateway device 10 can remove or delete the corresponding static ARP binding (entry) from the local ARP table. Processing can subsequently loop back to block 220 to check the lifetime of another host in the ARP table, as shown by path 228.

The operations of FIGS. 5-7 are illustrative. If desired, other ways for managing or updating the lifetime of static ARP entries in an ARP table can be employed. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. In some embodiments, the described operations may be distributed in a larger system.

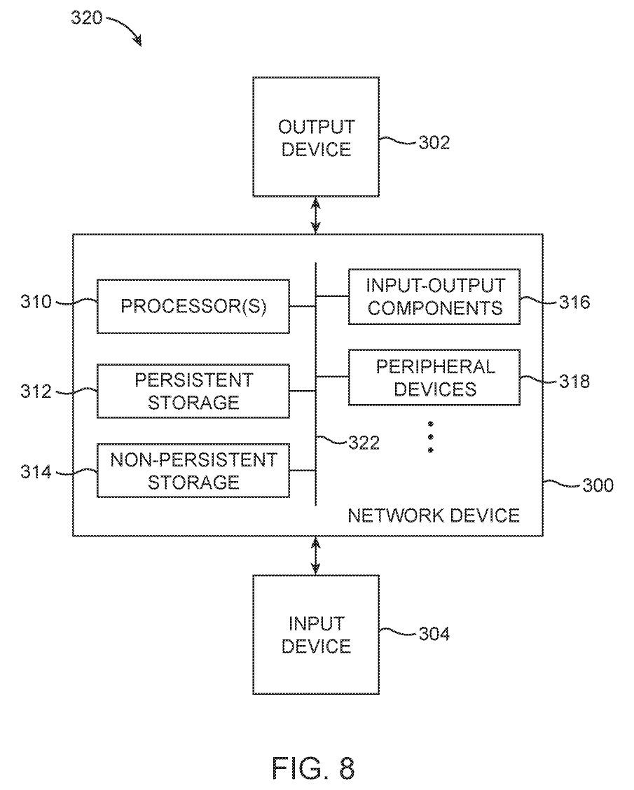

The foregoing embodiments may be made part of a larger system. FIG. 8 shows a system such as data processing system 320. Data processing system 320 may include a network device 300 optionally coupled to an input device 104 and/or an output device 102. Network device 300 may represent a network or WiFi gateway device 10 described in connection with the embodiments of FIGS. 1-7. Network device 300 may include one or more processors 310 (e.g., CPU 12 of FIG. 1), storage circuitry such as persistent storage 312 (e.g., flash memory or other electrically-programmable read-only memory configured to form a solid-state drive, a hard disk drive, etc.), non-persistent storage 314 (e.g., volatile memory such as static or dynamic random-access memory, cache memory, etc.), or any suitable type of computer-readable media for storing data, software, program code, or instructions, input-output components 316 (e.g., communication interface components such as a Bluetooth® interface, a WiFi interface, an Ethernet interface, an optical interface, and/or other networking interfaces for connecting device 300 to the Internet, a local area network, a wide area network, a mobile network, other types of networks, and/or to another network device), peripheral devices 318, and/or other electronic components. These components can be coupled together via a system bus 322. Network device 300 can be coupled to one or more output devices 302 and/or to one or more input device 304.

System 320 may be part of a digital system or a hybrid system that includes both digital and analog subsystems. System 320 may be used in a wide variety of applications as part of a larger computing system, which may include but is not limited to: a datacenter, a financial system, an e-commerce system, a web hosting system, a social media system, a healthcare/hospital system, a computer networking system, a data networking system, a digital signal processing system, an energy/utility management system, an industrial automation system, a supply chain management system, a customer relationship management system, a graphics processing system, a video processing system, a computer vision processing system, a cellular base station, a virtual reality or augmented reality system, a network functions virtualization platform, an artificial neural network, an autonomous driving system, a combination of at least some of these systems, and/or other suitable types of computing systems.

The methods and operations described above in connection with FIGS. 1-8 may be performed by the components of a network device using software, firmware, and/or hardware (e.g., dedicated circuitry or hardware). Software code for performing these operations may be stored on non-transitory computer readable storage media (e.g., tangible computer readable storage media) stored on one or more of the components of the network device. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the network device (e.g., processor 12 and/or processor 16 of FIG. 1, processor 310 of FIG. 8, etc.).

The foregoing is merely illustrative and various modifications can be made to the described embodiments. The foregoing embodiments may be implemented individually or in any combination.

What is claimed is:

1. A method of operating a network device, comprising:
with a dynamic host configuration protocol (DHCP) relay agent executed on one or more processors of the network device, performing a handshake by relaying a plurality of messages between a host device and a DHCP server;
while relaying the plurality of messages between the host device and the DHCP server, deriving an IP-to-MAC binding for the host device; and
with an address resolution protocol (ARP) agent executed on one or more processors of the network device, programming a static ARP entry in an ARP table using the derived IP-to-MAC binding for the host device.

2. The method of claim 1, wherein relaying the plurality of messages comprises:
relaying a discover message from the host device to the DHCP server, wherein the discover message includes a media access control (MAC) address of the host device; and
relaying an offer message from the DHCP server to the host device, wherein the offer message includes an internet protocol (IP) address being assigned to the host device.

3. The method of claim 2, wherein relaying the plurality of messages further comprises:
relaying a request message from the host device to the DHCP server; and
relaying an acknowledge message from the DHCP server to the host device, wherein the acknowledge message includes the IP address and the MAC address that are used for deriving the IP-to-MAC binding.

4. The method of claim 1, further comprising:
managing a lifetime of the static ARP entry in the ARP table.

5. The method of claim 4, wherein managing the lifetime of the static ARP entry in the ARP table comprises:
with the DHCP relay agent, querying the DHCP server for a lease time associated with the IP-to-MAC binding; and
with the ARP agent, selectively updating the static ARP entry in the ARP table based on the queried lease time.

6. The method of claim 4, wherein managing the lifetime of the static ARP entry in the ARP table comprises:
with the DHCP relay agent, receiving a DHCP renew or release message from the host device and forwarding the received DHCP renew or release message to the DHCP server; and
with the ARP agent, selectively updating the static ARP entry in the ARP table based on the received DHCP renew or release message.

7. The method of claim 4, wherein managing the lifetime of the static ARP entry in the ARP table comprises:
sending a plurality of unicast ARP requests to the host device to check if the host device is still present; and
subsequent to receiving no response to the plurality unicast ARP requests from the host device, using the ARP agent to selectively remove the static ARP entry from the ARP table.

8. The method of claim 1, wherein the network device comprises a WiFi gateway.

9. The method of claim 8, further comprising:
conveying data packets to and from the host device via a wireless access point based on the derived IP-to-MAC binding for the host device.

10. The method of claim 9, further comprising:
conveying the data packets to and from the host device via a network underlay configured to provide a virtual tunnel having a first endpoint coupled to the network device and a second endpoint coupled to the wireless access point.

11. A method of operating a network device, comprising:
deriving an IP-to-MAC binding for a host device using dynamic host configuration protocol (DHCP) operations;
programming a static address resolution protocol (ARP) entry in an ARP table based on the derived IP-to-MAC binding for the host device; and
managing a lifetime of the static ARP entry in the ARP table.

12. The method of claim 11, wherein managing the lifetime of the static ARP entry in the ARP table comprises:
querying a DHCP server for a lease time associated with the IP-to-MAC binding; and
selectively updating the static ARP entry in the ARP table based on the queried lease time.

13. The method of claim 12, wherein selectively updating the static ARP entry in the ARP table based on the queried lease time comprises:
in response to receiving an expired lease time, removing the static ARP entry from the ARP table.

14. The method of claim 11, wherein managing the lifetime of the static ARP entry in the ARP table comprises:
receiving a DHCP renew or release message from the host device and forwarding the received DHCP renew or release message to a DHCP server; and
selectively updating the static ARP entry in the ARP table based on the received DHCP renew or release message.

15. The method of claim 14, wherein selectively updating the static ARP entry in the ARP table based on the received DHCP renew or release message comprises:
in response to receiving a DHCP release message, removing the static ARP entry from the ARP table; and
forwarding the DHCP release message to the DHCP server.

16. The method of claim 11, wherein managing the lifetime of the static ARP entry in the ARP table comprises:
sending a plurality of unicast ARP requests to the host device to check if the host device is still present; and
subsequent to receiving no response to the plurality unicast ARP requests from the host device, selectively removing the static ARP entry from the ARP table.

17. A method of operating a gateway device, comprising:
performing a dynamic host configuration protocol (DHCP) handshake by relaying a plurality of messages between a client device and a DHCP server;
during the DHCP handshake, deriving an IP-to-MAC mapping for the client device; and
installing a static entry in an address resolution protocol (ARP) cache using the derived IP-to-MAC mapping for the client device.

18. The method of claim 17, further comprising:
managing a lifetime of the static entry in the ARP cache by:
querying a lease duration from the DHCP server;
intercepting renew or release messages sent from the client device to the DHCP server; or
sending one or more unicast ARP requests to the client device.

19. The method of claim 18, further comprising:
in response to receiving a queried lease duration that is expired, removing the static entry from the ARP cache;
in response to receiving a release message from the client device, removing the static entry from the ARP cache; and
in response to receiving no response to the unicast ARP requests, removing the static entry from the ARP cache.

20. The method of claim 17, further comprising:
disabling a dynamic ARP protocol to prevent the gateway device from replicating a plurality of ARP requests.
